(19) United States
(12) Patent Application Publication
(10) Pub. No.: US 2010/0241445 A1
(43) Pub. Date: Sep. 23, 2010

(54) APPARATUS AND METHOD FOR EFFECTUATING A HEALTH-CARE RELATED PROGRAM

(75) Inventors: Derek Rago, Scottsdale, AZ (US); Peggy Yelinek, Scottsdale, AZ (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: McKesson Specialty Arizona Inc.

(21) Appl. No.: 12/409,156

(22) Filed: Mar. 23, 2009

(51) Int. Cl. G06Q 30/00; G06Q 50/00; G06Q 40/00

(52) U.S. Cl. 705/2; 705/30; 705/35; 705/14.13

(57) ABSTRACT

A method is provided that includes receiving input to enroll a patient in a program of an administrator, where the program is directed to a cosmetic medication administrable to the patient by a prescriber. The method also includes receiving recordation of an administering or intended administering of the medication to the enrolled patient by the prescriber, where recordation of the administering or intended administering initiates a request for a rebate on a price of the medication. Further, the method includes processing the request to determine an amount of the rebate, returning a response to the request including an indication of the amount of the rebate, and remitting the rebate amount to the patient.

### FIELD OF THE INVENTION

The present invention generally relates to systems and methods for effectuating a healthcare-related program at least partially based on point-of-service (POS) transactions and, more particularly, to systems and methods for effectuating a cosmetic medication program at least partially based on a POS transaction with a physician.

### BACKGROUND OF THE INVENTION

For a number of years, pharmaceutical manufacturers have provided patients with personalized marketing services and programs designed to encourage product adoption or promote continued use of their brand medications. These services and programs have included, for example, rebates, point-of-sale free product samples, ATM gift cards, educational mailings and refill reminders. The impact of these programs is diminished, however, when accurate and timely information on the patient's use of the medication before and after the service is unavailable.

Also for a number of years, pharmaceutical companies have expanded upon the practice of donating free samples of brand medications to physicians for distribution to patients by directly providing patients with mail-in rebates and electronic rebates at the point of sale or service (provided via certain sample vouchers). More recently, companies have followed trends from other consumer markets by providing monetary incentives in the form of debit “gift” cards or credit card mechanisms. The incentives provided by these cards have not been linked to the fulfillment of the associated prescription, and in many cases consumers have used the cards to purchase non-pharmaceutical items at their drug retailer or elsewhere. In addition, fraudulent use of the cards has been cited including examples of using the entire balance on a debit card for one (rather than the intended multiple) prescription transaction. This type of abuse is currently being addressed through “instant rebate” debit card programs that allow for only one rebate per store transaction, but the systems and data are still de-linked from the prescription dispensing event. Similar misuse has been experienced with credit card instruments.

In addition to the foregoing, administration of various medications by the physician at the physician's office have limited the effectiveness of personalized marketing services and programs designed to encourage product adoption or promote continued use of their brand medications. For example, cosmetic medications (sometimes referred to as lifestyle medications or lifestyle drugs) are generally those designed to address conditions for improving a patient's quality of life but that are otherwise considered unworthy of treatment. These conditions are generally relatively minor and non-life threatening, such as baldness, impotence, wrinkles, obesity or the like. And in addition to generally being administered at the physician's office, cosmetic medications are often not covered by or are often otherwise excluded by health or other insurance plans.

### SUMMARY OF THE INVENTION

In light of the foregoing background, exemplary embodiments of the present invention provide an improved apparatus, method and computer program product for effectuating a healthcare-related program, and in particular a cosmetic medication rebate program. According to one aspect of the present invention, a method is provided for effectuating a program of an administrator that includes various steps one or more of which may be performed by one or more processors of the administrator. The method of this aspect includes receiving input to enroll a patient in a program of an administrator, where the program is directed to a medication administrable to the patient by a prescriber, such as a physician, nurse practitioner or the like. The method also includes receiving recordation of an administering or intended administering of the medication to the enrolled patient by the prescriber, where recordation of the administering or intended administering initiates a request for a rebate on a price of the medication.

The method of this aspect also includes processing the request to determine an amount of the rebate, returning a response to the request including an indication of the amount of the rebate, and remitting the rebate amount to the patient. Remitting the rebate amount may include, for example, directing the prescriber to charge the patient the full price of the medication, and sending the rebate amount to the patient as a mailed rebate, stored-value card or added value to a stored-value card. Alternatively, for example, remitting the rebate amount may include directing the prescriber to charge the patient the full price of the medication less the rebate amount, and sending the rebate amount to the prescriber as a reimbursement.

Like the patient, the prescriber is also enrolled in the program of the administrator. In this regard, the prescriber may be enrolled in a plurality of programs of the administrator, where the programs are directed to respective medications administrable by a prescriber. Thus, the received recordation may include identification of the program directed to the medication administered or intended to be administered to the patient. And the request may be processed in accordance with established rebate rules for the identified program.

Regarding enrollment of the prescriber, the method may further include receiving input to enroll the prescriber in a plurality of programs of the administrator, where the programs are directed to respective, different medications administrable by a prescriber and include the program to which the patient is enrolled. The prescriber in this instance may be enrolled in the program to which the patient is enrolled before or after receiving input to enroll the patient in the respective program. Enrolling the prescriber in multiple programs, however, may enable occurrences of receiving input, receiving recordation, processing the request, returning the response and remitting the rebate amount for a plurality of different patients enrolled in a plurality of programs directed to respective, different medications administrable by a prescriber.

According to other aspects of the present invention, an apparatus and computer program product provided. As indicated above and explained below, the apparatus, method and computer program product of exemplary embodiments of the present invention may solve the problems identified by prior techniques and may provide additional benefits.

### BRIEF DESCRIPTION OF THE DRAWINGS

Having thus described the invention in general terms, reference will now be made to the accompanying drawings, which are not necessarily drawn to scale, and wherein:

FIG. 1 is a schematic block diagram of a system for effectuating a health-care related program in accordance with exemplary embodiments of the present invention;

FIG. 2 is a schematic block diagram of an apparatus that may be operable by or otherwise configured to operate as a patient, physician, administrator and/or sponsor, in accordance with exemplary embodiments of the present invention;

FIG. 3 is a schematic block diagram more particularly illustrating an administrator, in accordance with one embodiment of the present invention;

FIGS. 4, 5 and 6 are control flow diagrams including various steps in a method of effectuating a program at least partially based on point-of-sale or point-of-service transactions in accordance with exemplary embodiments of the present invention; and

FIGS. 7-15 illustrate various exemplary front end displays that may be presented to a physician, in accordance with one exemplary embodiment of the present invention.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. For example, as shown and described herein, reference may be made to a “physician.” It should be understood, however, that functions attributed to a physician may be equally performed by any of a number of prescribers, including a physician, nurse practitioner or the like. Like numbers refer to like elements throughout.

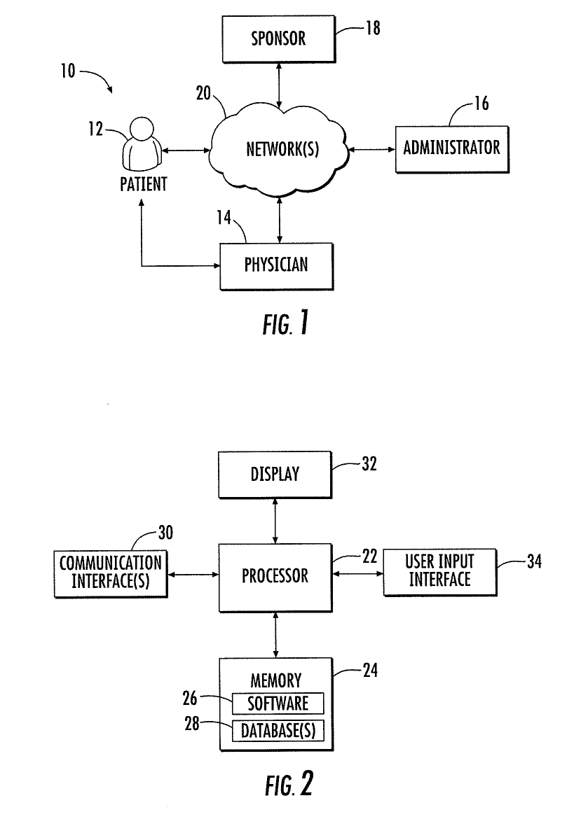

Referring to FIG. 1, a system 10 for effectuating a health-care related program includes one or more patients 12, physicians 14 administrators 16 and/or sponsors 18 (one of each being shown). Each patient 12 is configured to directly and/or indirectly communicate with one or more physicians, administrators and/or sponsors. Similarly, each physician is configured to directly and/or indirectly communicate with one or more patients and/or administrators. Each administrator is configured to directly and/or indirectly communicate with one or more patients and/or physicians. Further, each sponsor is configured to directly and/or indirectly communicate with one or more patients, physicians and/or administrators. In this regard, the patient(s), physician(s), administrator(s) and sponsor(s) can be configured to directly and/or indirectly communicate with one another across one or more networks 20. The network(s) can comprise any of a number of different combinations of one or more different types of networks, including data and/or voice networks. For example, the network(s) can include one or more data networks, such as a local area network (LAN), a metropolitan area network (MAN), and/or a wide area network (WAN) (e.g., Internet), and include one or more voice networks, such as a public-switched telephone network (PSTN). Although not shown, the network(s) may include one or more switches, routers and/or other components for relaying data, information or the like between the patient(s), physician(s), administrator(s) and/or sponsor(s).

The patient 12, physician 14, administrator 16 and sponsor 18 can comprise any one or more of a number of different entities, devices or the like configured to operate in accordance with embodiments of the present invention. In this regard, one or more of the patient, physician, administrator and sponsor can comprise, include or be embodied in one or more processing apparatuses, such as one or more of a laptop computer, desktop computer, server computer or the like. Additionally or alternatively, one or more of the patient, physician, administrator and sponsor can comprise, include or be embodied in one or more portable electronic devices, such as one or more of a mobile telephone, portable digital assistant (PDA), pager or the like. For example, the patient, physician, administrator and/or sponsor can each comprise a processing apparatus configured to communicate with one another across the Internet (e.g., network 20).

It should be understood, however, that one or more of the patient 12, physician 14, administrator 16 and sponsor 18 can comprise or otherwise be associated with a user carrying out the functions of the respective apparatus. For example, the patient can comprise a patient user (patient or another operator under direction of the patient) communicating across a PSTN (e.g., network 20) or in person with an administrator user (administrator or another operator under direction of the administrator) operating one or more administrator processing apparatuses, where the administrator user and processing apparatus(es) collectively comprise the administrator. Similarly, for example, the patient can comprise a patient user communicating across a PSTN or in person with a physician user (physician or another operator under direction of the physician) operating one or more physician processing apparatuses, where the physician user and processing apparatus(es) collectively comprise the physician. In such instances, the administrators can comprise one or more administrator processing apparatuses communicating across a network (e.g., the Internet) with the physician processing apparatus(es). Alternatively, in such instances, the administrator can comprise a user operating one or more processing apparatuses, where the administrator user is configured to communicate with the physician user across a PSTN. As explained below, then, the term “patient” can refer to a patient including a patient user and/or one or more patient processing apparatuses. Similarly, a “physician” can refer to a physician including a physician user and/or one or more physician processing apparatuses. An “administrator” can refer to an administrator user and/or one or more administrator processing apparatuses. And a “sponsor” can refer to a sponsor user and/or one or more sponsor processing apparatuses.

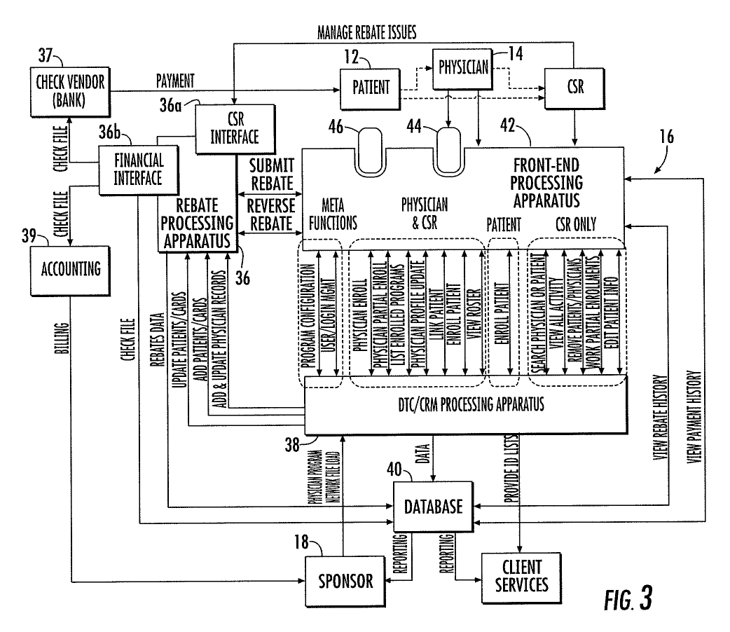

Referring now to FIG. 2, a block diagram of an apparatus that may be configured to operate as a patient 12, physician 14, administrator 16 and/or sponsor 18 is shown in accordance with exemplary embodiments of the present invention. Although shown as separate entities, in some embodiments, one or more entities may support one or more of a patient, physician, administrator or sponsor, logically separated but co-located within the entit(ies). For example, a single apparatus may support a logically separate, but co-located physician and administrator. Also, for example, a single apparatus may support a logically separate, but co-located administrator and sponsor.

The apparatus that may be configured to operate as a patient 12, physician 14, administrator 16 and/or sponsor 18 includes various means for performing one or more functions in accordance with exemplary embodiments of the present invention, including those more particularly shown and described herein. It should be understood, however, that one or more of the apparatuses may include alternative means for performing one or more like functions, without departing from the spirit and scope of the present invention. More particularly, for example, as shown in FIG. 2, the apparatus can include a processor 22 connected to a memory 24. The memory can comprise volatile and/or non-volatile memory, and typically stores content, data or the like. In this regard, the memory may store software applications 26, instructions or the like for the processor to perform steps associated with operation of the apparatus in accordance with embodiments of the present invention. The memory may also store content transmitted from, and/or received by, the apparatus. In this regard, when the apparatus comprises an administrator, the memory may store one or more databases 28 for administering programs offered thereby, such as by storing information identifying or otherwise associated with patients and physicians enrolled in those programs, as explained below. As described herein, the software application(s) may each comprise software operated by the respective entities. It should be understood, however, that any one or more of the patient applications described herein can alternatively comprise firmware or hardware, without departing from the spirit and scope of the present invention.

In addition to the memory 24, the processor 22 can also be connected to at least one interface or other means for displaying, transmitting and/or receiving data, content or the like. In this regard, the interface(s) can include at least one communication interface 30 or other means for transmitting and/or receiving data, content or the like. In addition to the communication interface(s), the interface(s) can also include at least one user interface that can include one or more earphones and/or speakers, a display 32, and/or a user input interface 34. The user input interface, in turn, can comprise any of a number of devices allowing the apparatus to receive data from a user, such as a microphone, a keypad, a touch display, a joystick, or other input device.

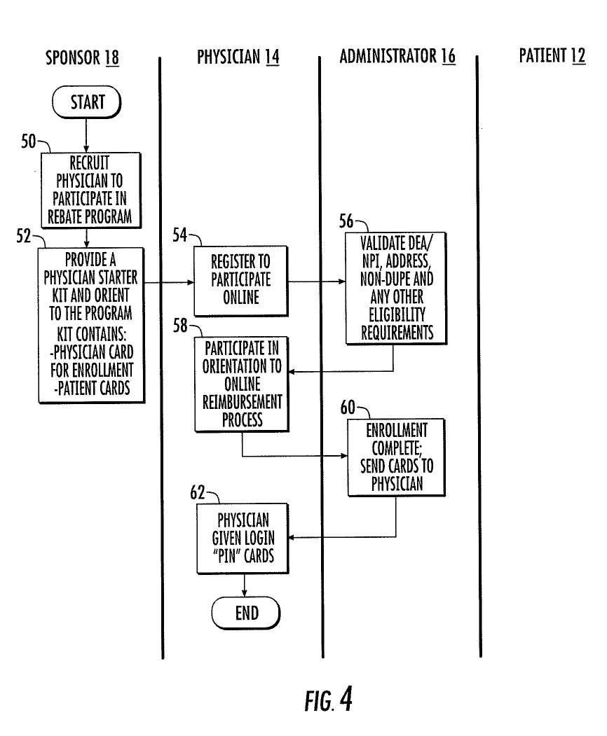

Reference is now made to FIG. 3, which more particularly illustrates an administrator 16 in accordance with exemplary embodiments of the present invention. As shown in FIG. 3, the administrator includes a plurality of processing apparatuses. It should be understood that each processing apparatus may include a processor, memory, communication interface(s), display and/or user input interface(s), such as in the same manner explained above with reference to FIG. 2. It should also be understood that, although shown as separate entities, in some embodiments, more than one of the illustrated processing apparatuses may be supported by a single processing apparatus, without departing from the spirit and scope of the present invention.

As shown in FIG. 3, the administrator 16 of exemplary embodiments of the present invention may include a rebate processing apparatus 36 configured to operate a transaction processing subsystem for processing rebates to patients 12 enrolled in one or more programs offered by the administrator. The transaction processing subsystem of the rebate processing apparatus may comprise a software package based on a claims processing system, such as the ProPBM™ prescription transaction processing system distributed by Prospective Health Services of Scottsdale, Ariz. The transaction processing subsystem may capture and/or adjudicate transactions for potential rebates provided under one or more programs offered by the administrator based on one or more business rules and/or attributes applicable to the respective program(s). In this regard, the rebate processing apparatus may include a CSR (customer service representative) interface 36a for communicating with CSR representatives of the administrator; and a financial interface 36b for communicating with a check vendor (bank) 37 for remitting rebates to patients 12, and for communicating with an accounting module 39 for billing rebates back to the sponsor 18.

One or more of the programs offered by the administrator 16 may have an associated sponsor 18, such as the manufacturer of a product or service to which the program(s) are directed. As such, the transaction processing subsystem of the rebate processing apparatus 36 may utilize relational database technology and advanced logic to assign multiple identification numbers to physicians and patients enrolled to participate in multiple programs offered by the administrator. Thus, to receive rebates under multiple programs of the administrator, as explained below, the physician user and/or patient user may be issued a respective membership card tied to each program or multiple programs from one or more sponsors (e.g., manufacturers). The membership card, then, may include among other pieces of information, an identifier (physician/patient identification number) and/or source code associated with the respective physician/patient, and/or one or more identifiers (program identification numbers) associated with programs of the administrator to which the respective physician/patient is enrolled.

As shown, the administrator 16 may also include a Direct to Client (DTC) and/or Customer Relationship Management (CRM) processing apparatus 38 for enrolling physicians 14 and patients 12 in one or more programs of the administrator, as well as providing one or more services to physicians and patients enrolled in program(s) of the administrator. The DTC/CRM processing apparatus may maintain or otherwise communicate with a database 40 for storing information associated with the program(s) and the physicians and patients enrolled in those program(s). The physician and patient information maintained in the database may include, for example, demographic information such as the physician's or patient's name, address, telephone number, e-mail address, and the like. The physician and patient information may also include the aforementioned physician or patient identification number and/or source code associated with the respective physician or patient, which may be included on a membership card issued to the physician or patient. More particular to patients, the patient information may further include answers to custom questions per request of an enrolled sponsor's request, and/or Health Insurance Portability and Accountability Act-based (HIPAA-based) information (depending on the program). And more particular to physicians, the physician information may further include the physician's drug enforcement administrator (DEA) number, national provider identifier (NPI), practice name, office address, telephone number, facsimile number and/or email address.

The physician and patient information may further include a listing of one or more program(s) of the administrator to which the physician or patient is enrolled (or program identification number(s) of such program(s)), one or more medications to which the physician's or patient's enrolled program(s) are applicable, any particular rebates associated with respective applicable medications, historical purchases of applicable medications, the timing and/or frequency of those historical purchases, any scheduled forthcoming purchases of applicable medications, or the like. Further, as explained in greater detail below, patients in a program may be linked to their respective physician in that program. Thus, the patient information may include a listing of one or more physicians who may be providing a medication under one or more programs to thereby link the patient with the respective physician(s); and the physician information may include various pieces of the aforementioned information regarding their linked patients, or this patient information may otherwise be linked to the respective physician's information.

As explained herein, the term “medication” may include any of a number of drugs, medicines, biologic or synthetic materials, compounds, formulations, devices or the like that may be administered to a patient such as by oral, topical, injectable, implantable manners or the like. The term “cosmetic medication” may generally refer to a medication administerable at the physician's office, and designed to address a condition for improving a patient's quality of life but that is otherwise considered unworthy of treatment (generally a relatively minor and non-life threatening condition, such as baldness, impotence, wrinkles, obesity or the like). These “cosmetic medications” are often not covered by or are often otherwise excluded by health or other insurance plans.

The administrator 16 may further include one or more front-end processing apparatuses for interfacing patients 12 and physicians 14 with the administrator. More particularly, for example, the administrator can include a front-end processing apparatus 42 that includes a physician front end 44, such as a software application front end, enrolling patients in one or more programs of the administrator. In addition, the physician front end may be for interfacing a physician with the transaction processing subsystem of the rebate processing apparatus 36. In this manner, the physician may initiate effectuation of a program for which a patient purchasing a medication is enrolled (as determinable based on patient information maintained in the database 40). The front-end processing apparatus may also include a patient front end 46 for enrolling patients in one or more programs of the administrator. The patient front end may enroll patients in any of a number of different manners. The front-end processing apparatus and front ends may be effectuated in any of a number of different manners. In one embodiment, for example, the front-end processing apparatus may comprise an application server configured to provide front ends comprising one or more Web pages or other graphical user interfaces (GUIs)—such as Web pages—via which physicians 14 or patients 12, or other parties under direction of physicians or patients (e.g., customer service representative—CSR—of the administrator) interact with the administrator.

In one more particular exemplary embodiment, the front end 44, 46 for each of the physician 14 and patient 12 may include a general front end from which a physician and patient, respectively, may register online to create an account with the administrator 16, and initially enroll in programs of the administrator. In addition, the front ends may include a more-specific front end customized for each registered/enrolled physician and patient, respectively. This customized front end may be access restricted (e.g., username/password) to only a particular physician or patient (or other party under direction of the particular physician or patient). The customized front end may permit the physician or patient to manage their respective account with the administrator (e.g., add, delete or modify their physician or patient information) and their enrollment in programs of the administrator (e.g., add, delete or modify enrollment in one or more programs). Also, the customized front end may permit the physician to query or otherwise view various pieces of information (patient information) regarding the respective physician's linked patients. In addition, if reimbursements are provided directly to patients, the customized front end of the patient may permit the patient to view scheduled payments for reimbursement to the patient. But if reimbursements are provided to patients through their physician, the customized front end of the physician may permit the physician to view scheduled payments for reimbursement to the physician.

As shown and described herein without loss of generality, the physicians may generally provide medication (e.g., prescription medication) to patients 12. It should be understood, however, that the patients and physicians may comprise or otherwise be associated with any of a number of other entities equally configured to perform the functions described herein. For example, the physicians can comprise any of a number of different entities configured to provide medications to customers, those medications being for which an administrator 18 is configured to effectuate a program, as explained below. As also shown and described herein, programs of the administrator may be associated with applicable medications, such as cosmetic medications, administered by a physician 14 at the physician's office. It should be understood, however, that one or more programs may be associated with other applicable goods and/or services, whether administered by the physician at the physician's office or otherwise, without departing from the spirit and scope of the present invention.

Exemplary embodiments of the present invention therefore provide an architecture for effectuating one or more programs at least partially based on point-of-sale (POS) transactions of medications at a physician or physician's office. In addition and in conjunction with such programs, the architecture of exemplary embodiments of the present invention may provide a patient (patient 12) with one or more services and/or rebates from a sponsor 18 of a program offered by the administrator 16, which may cover a portion of the expense for applicable cosmetic medications (qualifying medications). Each of these aforementioned features being briefly explained below before being explained in detail thereafter.

The architecture of exemplary embodiments of the present invention may be characterized as a personalized rebate program that uses data, such as data related to the timing and frequency of medication purchase events (good and/or service purchase events), along with other information, to drive appropriate services for individual patients 12 enrolled in a program. The architecture may integrate physician 14 rebate adjudication at the point of sale or service (POS) with services provided during or after the transaction. Medication purchase activity, demographics and other information for patients who opt-in to a program offered by the administrator 18 may be available thereto in any of a number of different ways. Based on business rules established by the administrator or a sponsor 18 of a program offered by the administrator, the administrator may link an event-based consumer management system with a network of participating physicians to capture patient medication purchase transactions for a brand of cosmetic medication along with other information in a patient record. This data, then, may “trigger” specified consumer services such as marketing services and/or interventions for the patients including, for example, refill reminders, reimbursement counseling services, clinical monitoring or counseling services, ATM gift cards, textbooks, educational mailings, or other activities to address specific drug and disease state issues or opportunities.

The architecture of exemplary embodiments of the present invention may also permit the administrator 16 or sponsor 18 of a program offered by the administrator to review and analyze the impact of services provided to patients (i.e., enrollees) enrolled in the program. In this regard, the architecture may integrate subsequent medication utilization data with information captured through the provision of services under the program of the administrator to measure changes in program compliance, product adherence, adverse events, therapeutic outcomes or the like, and may also trigger additional service events in response to each patient's individual program, service or product experience.

By initially opting-in to a particular program of the administrator 16, such as for a particular brand of medication, a patient 12 may also permit the administrator to enroll the patient in additional programs offered by the administrator, such as for other brands of medications. This enables the administrator to offer sponsors 18 streamlined access to willing patients, thus avoiding the marketing, card production, and enrollment processing costs associated with each new program participant.

In addition to or in lieu of managing various product services for pharmaceutical manufacturers, the architecture of exemplary embodiments of the present invention may provide patients 12 with a seamless rebate or other incentive covering a portion of the expense for medications to which the patient's enrolled programs are applicable (applicable medications), although it should be understood that such a rebate need not be monetary. In those instances in which the benefit is a financial incentive, however, the otherwise out-of-pocket expense may be determined by the administrator 16 in any of a number of different manners, such as via a connection of the administrator to physicians 14. The rebate may be provided as a mailed rebate, stored-value card (or added value to a stored-value card) mechanism or the like, and may be subject to less risk of fraud or abuse when the rebate is tied to the purchase of a medication administered by the physician at the physician's office.

For example, according to one embodiment of the present invention, a program could be designed to provide the patient a rebate on the cost of an administered medication. This rebate may be calculated instantly and provided to the patient at the point of sale and administering, or at some time thereafter. By using the databases, software, and business rules defined by the processor and transmitted via networks to the physician provider, this rebate could be defined and structured in a variety of ways to address individual patient, product, and cost issues. Although fixed rebates may be offered, such as a flat $5.00 rebate, other techniques may be used, such as variable discounts which reduce all patient costs to a fixed dollar amount. Alternatively, percentage discounts may be useful in certain circumstances (e.g., reduce patient calculated cost by 15%). In other instances, the manufacturer may deploy a program which combines certain aspects of these options to create additional rebate calculation options.

According to a further aspect of the present invention, a patient 12 may be provided a service and a secondary benefit. For instance, a pharmaceutical manufacturer may provide physicians with patient enrollment kits, which might include drug product information or other relevant references or materials deemed of potential value to newly-prescribed patients for a given manufacturer's product. For example, the information may include tips on healthy eating habits to help manage weight. Included within these patient kits, the manufacturer may also include a card which, upon activation, the patient may utilize to receive a rebate for medication administered by their physician 14. The patient could activate the card using one of multiple program interfaces such as the Internet, interactive voice response, facsimile, or by calling a toll free customer service number. After completing the activation process, the patient could present the card to the physician. When filling the prescription or otherwise administering the medication, the physician may input specific data elements provided on the card into the physician's computer system. The physician may then fill the prescription or otherwise administer the medication, and electronically and automatically submit a rebate request in accordance with the manufacturer card program, and a response may be received by the physician.

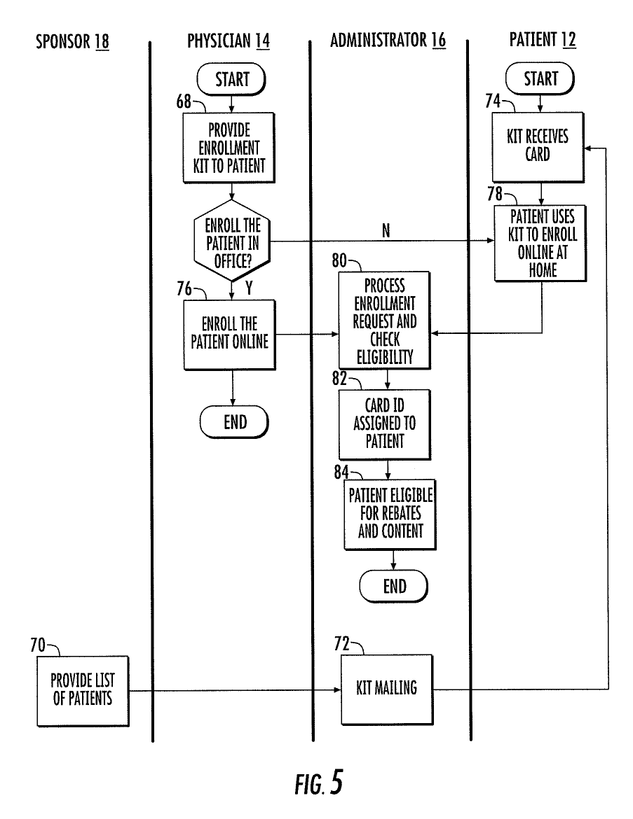

Reference is now made to FIGS. 4, 5 and 6, which illustrate control flow diagrams including various steps in a method of effectuating a program at least partially based on point-of-sale or point-of-service transactions in accordance with exemplary embodiments of the present invention. More particularly, referring to FIG. 4, a control flow diagram is provided for various steps in a method of enrolling a physician 14 in a program of the administrator 16, according to one exemplary embodiment of the present invention. As shown, a method of enrolling a physician may include the physician receiving information regarding participating in a program of the administrator. As shown in blocks 50 and 52, this may include a sponsor 18 of the program recruiting the physician, and providing the physician with a starter kit. The starter kit may include, for example, orientation materials and instructions on registering online with the administrator. The physician may then login to the physician front end 44 of the administrator to register online to create an account with the administrator and enroll in one or more programs of the administrator, as shown in block 54. During the registration process, the physician may enter into the physician front end a number of pieces of information related to the physician such as the aforementioned physician information, which may be stored in the database 40. In addition, this information may include a password for subsequent access to this information by the physician or another at the direction of the physician.

As or after the administrator 16 receives the physician's information via online registration, the administrator may validate various pieces of the information related to the physician 14 and/or check the physician's eligibility to participate in a program, such as in a real-time or near-real-time manner, as shown in block 56. This validation may include checking information received by the administrator in duplicate to verify their content (e.g., email address, password, etc.). Various other pieces of information such as the physician's DEA, NPI, address or the like may be validated by the administrator against corresponding information and/or eligibility rules received from the sponsor 18 prior to the physician's registration (e.g., in a preload batch of physicians and physician information). Alternatively, if the administrator has not received any corresponding information from the sponsor, the administrator may send the information received from the patient to the sponsor to enable the sponsor to validate the information and/or check the physician's eligibility—such as through a number of internal or external means.

If the administrator fails to validate any of the information subjected to validation, the administrator may respond in a number of different manners. For example, the administrator may notify the physician of the failure and offer the physician the opportunity to re-enter the respective information (or notify the sponsor with the opportunity to re-enter for preload batches of physicians), or reject the physician's registration.

If or once the administrator 16 receives the physician's information and successfully validates various pieces of that information, the administrator may complete the physician's registration with the administrator and enrollment in program(s) of the administrator, as shown in block 60. As registration/enrollment is completed, the administrator may send the physician (e.g., via email) a username/password for accessing the physician's account with the administrator, or the administrator may indicate a particular username/password to the physician—such as by indicating that the physician's email address serves as the username, and indicating acceptance of the physician's entered password. Before completing enrollment in the program(s), however, the physician may participate in an orientation to the program of the administrator and, if the rebate is provided to the patient via the physician, the online reimbursement process in accordance with that program, which may be provided to the physician via the physician front end 44 of the administrator 16, as shown in block 58.

As part of the registration/enrollment process, the physician 14 may receive a membership card for the physician, and/or one or more membership cards for distribution to one or more patients 12 of the physician. These membership cards may be received in the aforementioned starter kit provided to the physician, or may be sent to the physician at the conclusion of the physician's registration/enrollment, as shown at blocks 60 and 62. As indicated above, these membership cards may be tied to each program or multiple programs from one or more sponsors 18, and may include among other pieces of information, an identifier and/or source code associated with the respective physician/patient, and/or one or more identifiers (program identification numbers) associated with programs of the administrator 16. Thus, identifiers may be pre-generated and subsequently linked to physicians and patients as they register with the administrator and enroll in programs of the administrator, or may be dynamically generated and linked to physicians and patients during their registration/enrollment.

Also as part of the registration/enrollment process, the physician 14 may select one or more programs of the administrator 16 in which to enroll. For example, one or more programs may be selected according to program identification numbers provided to the physician in the aforementioned starter kit (e.g., from a membership card tied to those programs). Additionally or alternatively, one or more programs may be selected from a list of available programs to which the physician is eligible to participate, which may be compiled and provided to the physician by the administrator. After registering with the administrator, the administrator may from time to time provide the physician (e.g., via mail, email, the physician front end 44, etc.) with updates regarding new programs of the administrator in which, if eligible, the physician may participate. In this regard, as explained above, the physician front end may include an access-restricted, customized front end from which the physician may manage their respective account with the administrator (e.g., add, delete or modify information regarding the physician or patient) and their enrollment in programs of the administrator (e.g., add, delete or modify enrollment in one or more programs).

Referring to FIG. 5 a control flow diagram is provided for various steps in a method of enrolling a patient 12 in a program of the administrator 16, according to one exemplary embodiment of the present invention. As shown, a method of enrolling a patient may include the patient receiving information regarding participating in a program of the administrator. As shown in block 68, for example, this may include a physician 14 enrolled in the program providing the patient with an enrollment kit. Alternatively, as shown in blocks 70, 72 and 74, the sponsor may provide the administrator with a list of information for one or more patients, and from that information, the administrator may send an enrollment kit directly to the patient(s). The enrollment kit may include, for example, orientation materials and instructions on registering online with the administrator.

The patient 12 may register/enroll online in any of a number of different manners, including by or under the direction of the physician at the physician's office (e.g., at POS), as shown at block 76; or without direction from the physician offsite from the physician's office (e.g., at home), as shown at block 78. In another alternative, for example, the patient may communicate with CSR (e.g., by phone, chat, instant messaging, etc.) who may direct registration/enrollment of the patient. In any instance, the one directing the patient's registration/enrollment (e.g., physician or patient) may login to the patient front end 46 of the administrator 16 to register the patient online to create an account with the administrator and enroll in one or more programs of the administrator. During the registration process, the one directing the registration/enrollment may enter into the patient front end a number of pieces of information related to the patient such as the aforementioned patient information, which may be stored in the database 40. In addition, this information may include a password for subsequent access to this information by the patient or another at the direction of the patient.

Regardless of whether the administrator 16 receives the patient's information via online registration or a preload batch of patients, the administrator may validate various pieces of the information related to the patient 12 and/or check the patient's eligibility to participate in a program, such as in a real-time or near-real-time manner. This validation may occur in a separate portion of the registration/enrollment process, as shown in block 80, or as part of the administrator processing a batch of patients. Validation may be performed in a manner similar to that with a physician, and may include checking information received by the administrator in duplicate to verify their content (e.g., email address, password, etc.). In addition, validation may include checking eligibility of the patient to enroll in program(s) of the administrator. Also similar to with the physician, if the administrator fails to validate any of the information subjected to validation, the administrator may respond in a number of different manners. For example, the administrator may notify the patient or one directing registration/enrollment of the patient of the failure and offer the opportunity to re-enter the respective information (or notify the sponsor with the opportunity to re-enter for preload batches of patients), or reject the patient's registration.

If or once the administrator 16 receives the patient's information and successfully validates various pieces of that information and the patient's eligibility to participate, the administrator may complete the patient's registration with the administrator and enrollment in program(s) of the administrator. As registration/enrollment is completed, the administrator may send the patient 12 (e.g., via email) a username/password for accessing the patient's account with the administrator, or the administrator may indicate a particular username/password to the patient—such as by indicating that the patient's email address serves as the username, and indicating acceptance of the patient's entered password. Also, as part of the registration/enrollment process, the patient may receive a membership card. The membership card may be received in the aforementioned enrollment kit provided to the patient (see blocks 68, 74), or may be sent to the patient at the conclusion of the patient's registration/enrollment. As with enrolling the physician, an identifier and/or source code associated with the respective patient, and/or one or more identifiers (program identification numbers) associated with programs of the administrator 16, may be pre-generated and subsequently linked to the patient as the patient registers with the administrator and enroll in programs of the administrator, or may be dynamically generated and linked to physicians and patients during their registration/enrollment, as shown in block 82.

Also as part of the registration/enrollment process, the patient 12 may select one or more programs of the administrator 16 in which to enroll, after which the patient may be eligible to receive rebates and/or other content (e.g., educational content), as shown in block 84. For example, one or more programs may be selected according to program identification numbers provided to the patient in the aforementioned enrollment kit (e.g., from a membership card tied to those programs). Additionally or alternatively, one or more programs may be selected from a list of available programs to which the patient is eligible to participate, which may be compiled and provided to the patient by the administrator. After registering with the administrator, the administrator may from time to time provide the patient (e.g., via mail, email, the patient front end 46, etc.) with updates regarding new programs of the administrator in which, if eligible, the patient may participate. In this regard, as explained above, the patient front end may include an access-restricted, customized front end from which the patient may manage their respective account with the administrator (e.g., add, delete or modify information regarding the patient) and their enrollment in programs of the administrator (e.g., add, delete or modify enrollment in one or more programs).

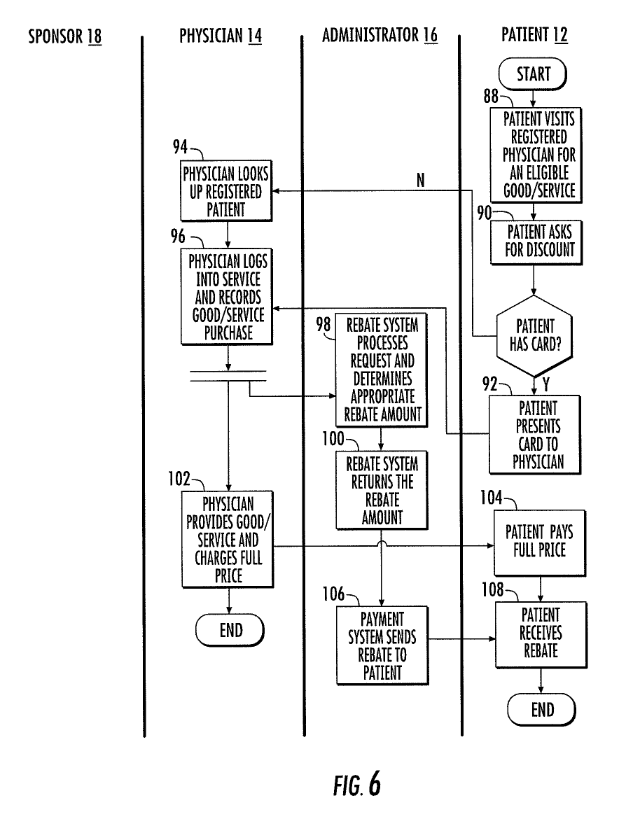

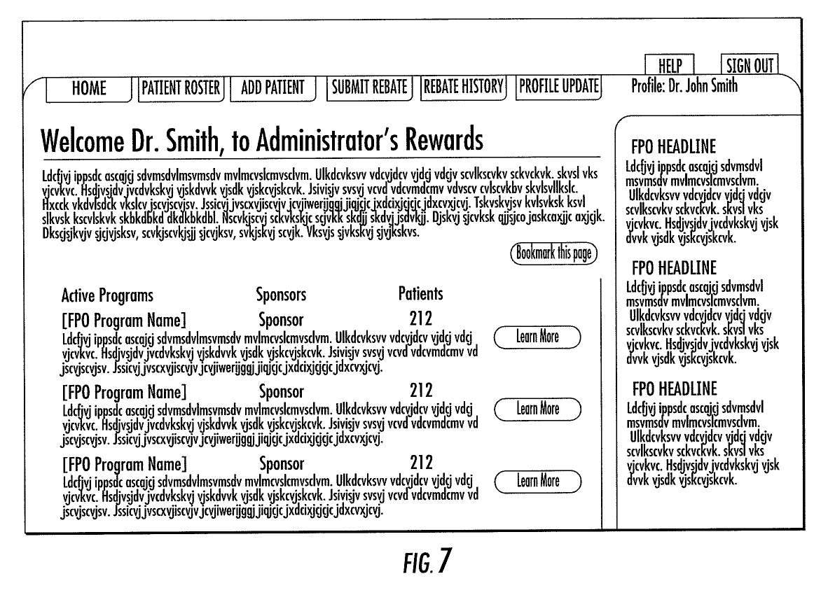

Irrespective of exactly how the physician 14 and patient 12 are enrolled with one or more programs of the administrator 16, for a program in which the patient and their administering physician are both enrolled, the patient may thereafter be eligible to receive (if so established in accordance with program business rules) a rebate for medications administered by the respective physician to which the respective program is applicable. Reference is now made to FIG. 6, which illustrates a control flow diagram of various steps in a method of effectuating a program of an administrator, according to one exemplary embodiment of the present invention. As shown at blocks 88 and 90, the method of one exemplary embodiment includes the patient 12 visiting a physician 14 for receiving an applicable medication and requesting a discount or rebate for that medication, in which both the patient and physician are enrolled in the same program for which the medication is eligible for a rebate. The respective purchase may be effectuated in any of a number of different manners such as, for example, by purchasing a qualifying medication from the physician, and presenting a membership card (or patient identification number and/or source code otherwise printed on such a card) for the program to the physician at the point of service (POS), as shown at block 92. In various instances, however, the patient may not have their card to present, and in such instances, the patient may instead supply the physician with one or more pieces of patient information from which the physician may look up, with the administrator, the patient and the patient's identification number and/or source code otherwise printed on their membership card, as shown in block 94.

After the patient 12 presents the physician 14 with their membership card or the physician looks up the patient, the physician may log into the administrator 16 via the physician front end 44 (unless already logged-in so as to look up the patient), and record the applicable medication as being received by the patient to thereby initiate a rebate request, as shown in block 96. The administrator, or more particularly the rebate processing apparatus 36 of the administrator, may receive the physician's recordation of the applicable medication received by the patient, and process a rebate request to calculate an appropriate rebate amount for the respective medication, as shown in block 98. In this regard, the rebate processing apparatus may calculate the rebate amount based on pre-established program rebate rules. If the rebate processing apparatus successfully calculates a rebate amount, the rebate processing apparatus may return the rebate amount to the physician, as shown in block 100. Otherwise, the rebate processing apparatus may return an error or rejection notice to the physician, and may provide the physician with an indication of the error or rejection. In either instance, the administrator may process the rebate request and provide a response (rebate amount, error or rejection notice) in real time or near-real-time with the rebate request.

If the rebate processing apparatus 36 returns a rebate amount, the administrator 16 may remit that amount to the patient 12 in any of a number of different manners, either at or after the time of service; and may remit the rebate real-time or near-real-time at the time of service, or at some point after the time of service. As shown in blocks 102 and 104, for example, the physician may provide the applicable medication and be directed by the administrator to charge the patient full price. The administrator, in the meantime, may remit the calculated rebate amount to the patient, who may receive the rebate as a mailed rebate, stored-value card (or added value to a stored-value card) mechanism or the like, as shown in blocks 106 and 108. In any instance of remitting the rebate to the patient, the administrator may bill the sponsor 18 of the respective program for the rebate, which may include the rebate amount plus any fees or costs associated with administering the program or processing the rebate (if so desired).

Although the foregoing described the rebate as being provided directly to the patient 12 from the administrator 16, the rebate may be alternatively provided to the patient via the physician 14. In such an instance, the returned rebate amount may be provided to the physician, who may in turn be directed by the administrator to charge the patient the balance of full price for the appropriate medication less the rebate amount; and the patient may in turn pay a rebated price. The administrator may then reimburse the physician for the rebate amount, such as by issuing a reimbursement check to the physician. The administrator in such instances may send a reimbursement check to the physician for each patient transaction, or alternatively, may compile reimbursement amounts for patient transactions over a period of time (e.g., month) and issue a reimbursement check for the compiled reimbursement amounts.

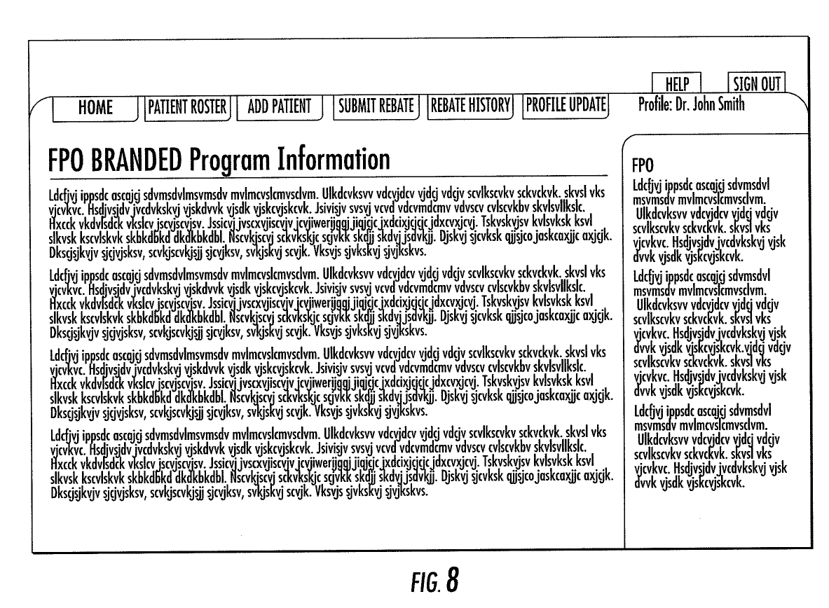

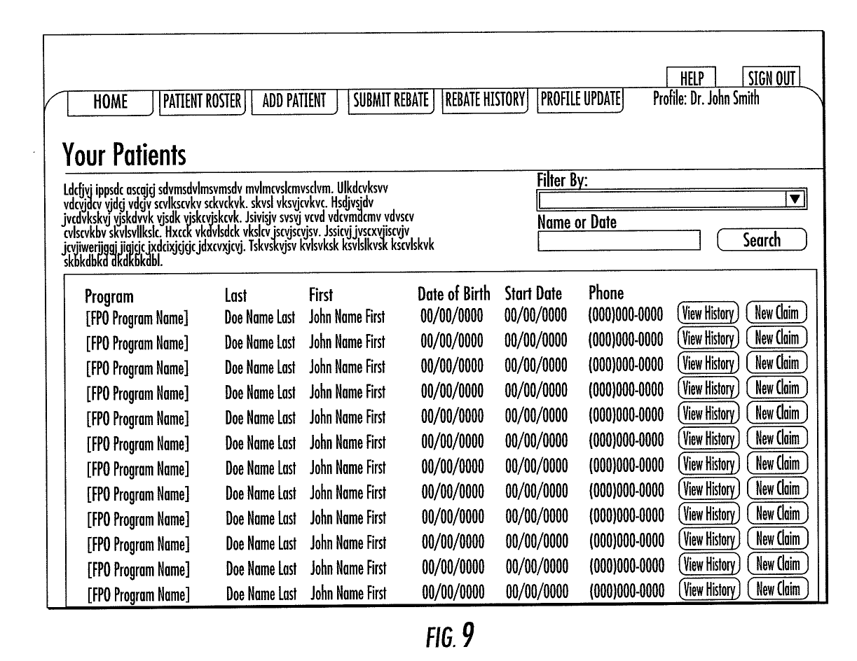

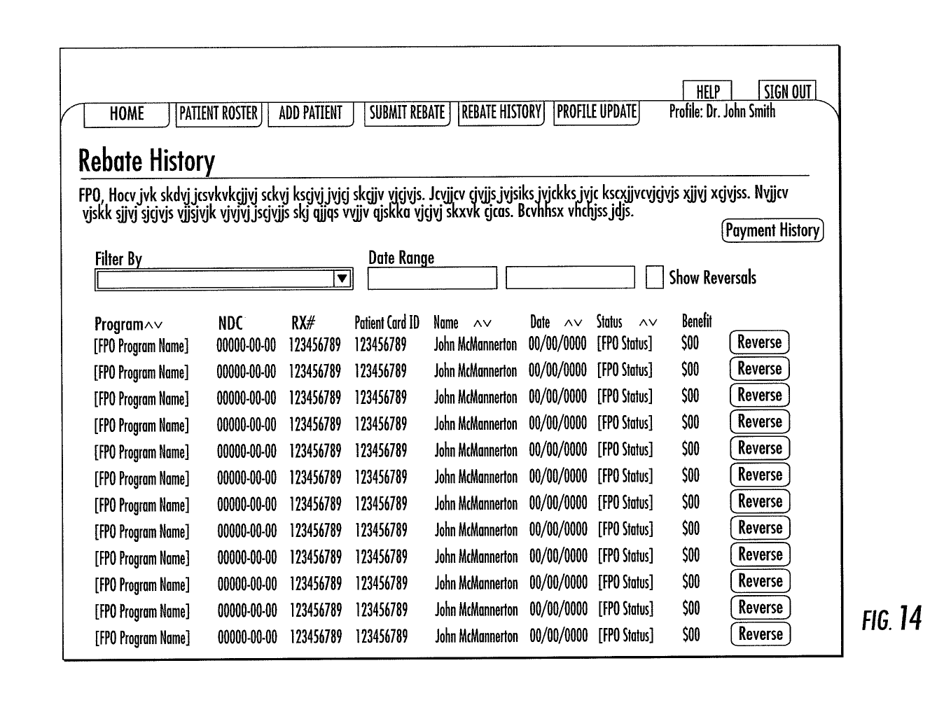

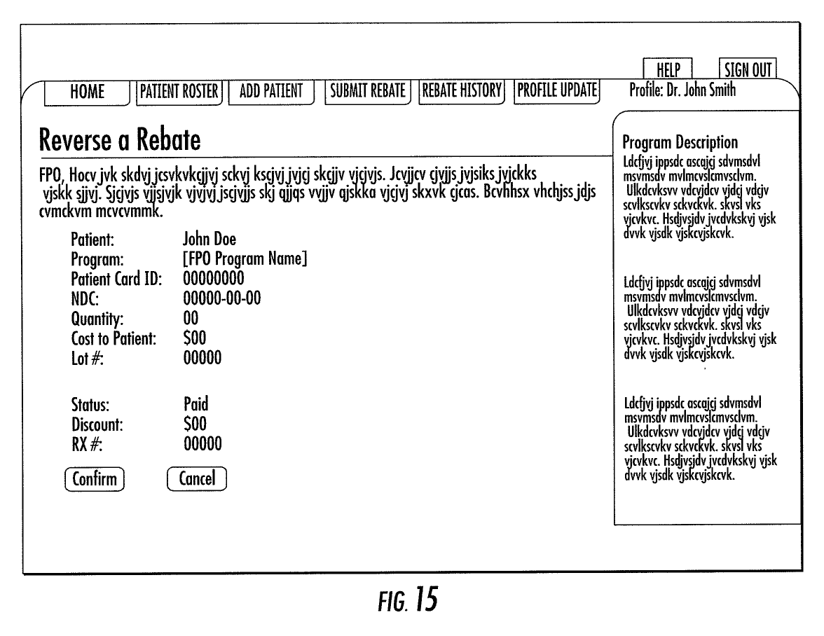

To further highlight aspects of exemplary embodiments of the present invention, reference is now briefly made to FIGS. 7-15, which illustrate various exemplary front end displays that may be presented by the physician front end 44 of the administrator 16. Various ones of the displays include letters and phony copy (i.e., “greek”), but it should be understood that this greek merely illustrates a location for real copy during implementation of exemplary embodiments of the persent invention. Each of the illustrated front end displays may be customized front-end displays, which are access restricted to a particular physician (here, Dr. John Smith). As shown in FIG. 7, after logging in to the physician front end, the front end may present to the physician a home display including various pieces of information, such as a list of programs to which the physician is enrolled including a name and description, sponsor and number of enrolled patients (in general and/or linked to the patient). From this display, the physician may select a program to learn additional information about the respective program, as shown in FIG. 8.

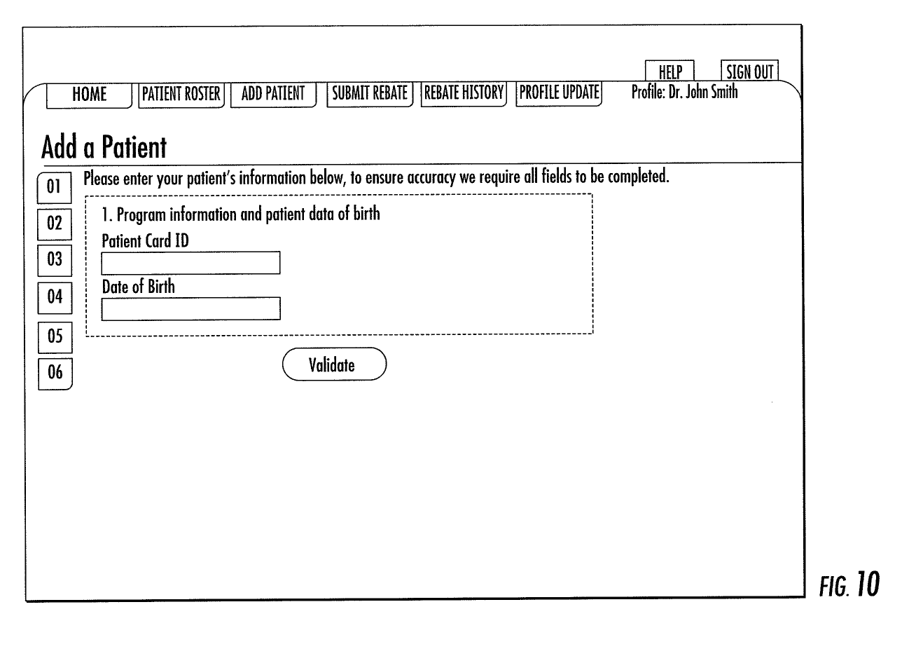

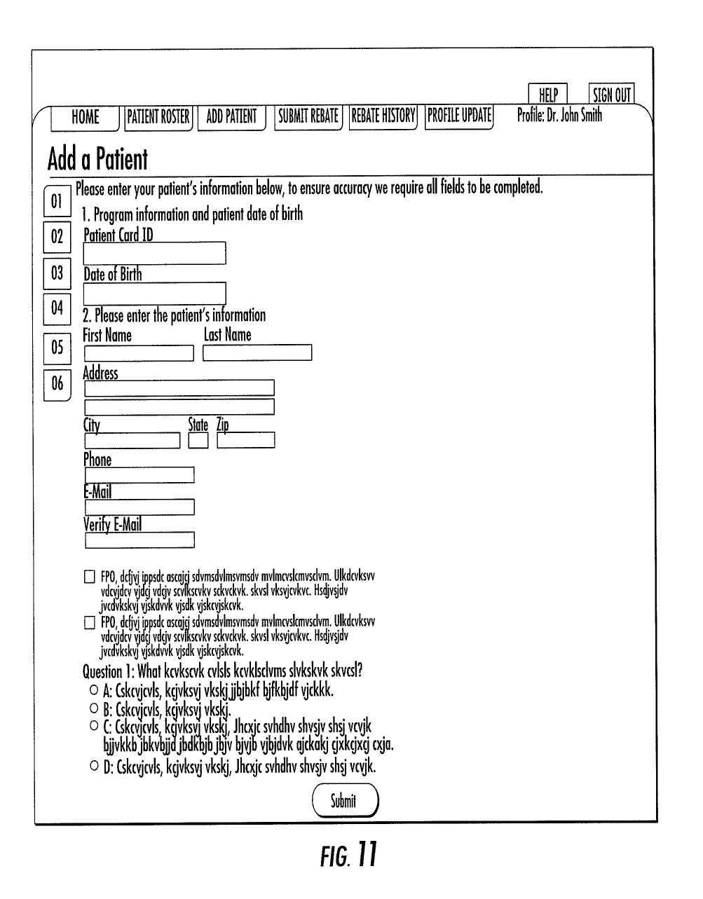

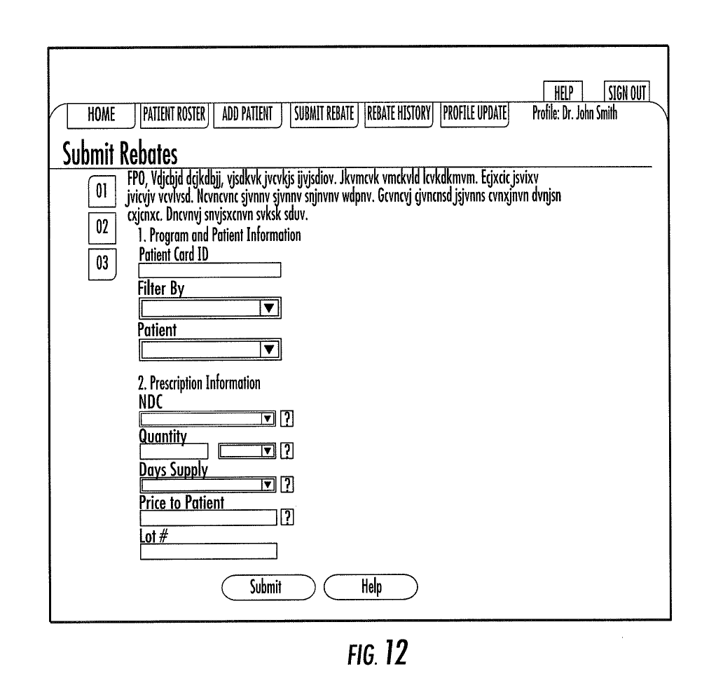

Also from the home display, the physician 14 may access or otherwise navigate between the home display other front end displays, such as from selectable tabs at or near a top portion of the displays as shown in FIG. 7 (as well as FIGS. 8-15). From one of these other front end displays, the physician may access a roster of patients 12 that are linked to the physician in various programs of the administrator 16, and access various pieces of patient information with respect to those patients, as shown in FIG. 9. And as shown in FIGS. 10 and 11, the physician may access front end displays from which the physician may add a patient to those linked with the physician, and from which the physician may enroll a patient in a program of the administrator (e.g., a program to which the physician is already enrolled).

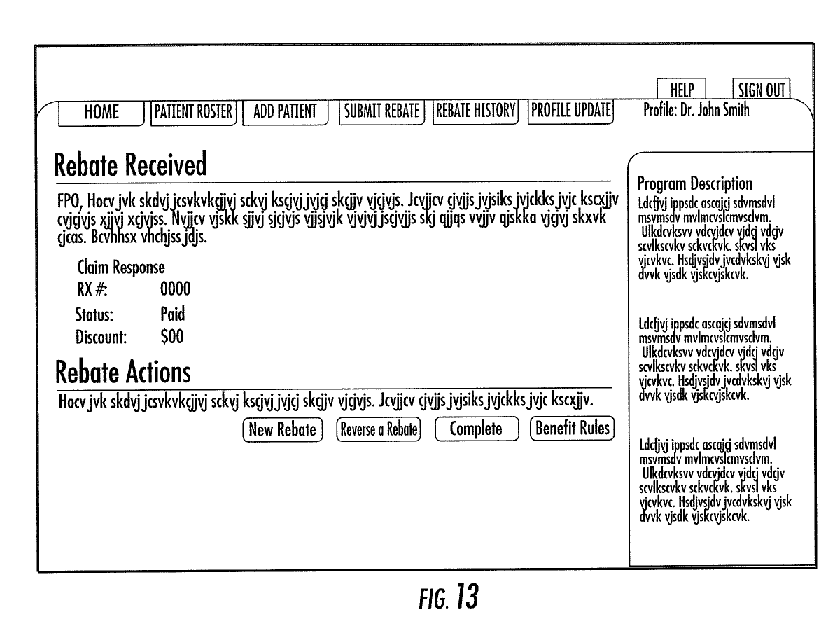

As shown in FIGS. 12, 13 and 14, the physician may also access a front end display from which the physician may initiate a rebate request with the administrator 16, review information regarding a submitted rebate request and its status, as well as review a history of submitted rebate requests. At various instances, it may be desirable to permit a physician to reverse a rebate or rebate request, which may be requested via various physician front end displays, such as those shown in FIGS. 12, 13 and 14, and more particularly in FIG. 15. Rebates may be reversed for any of a number of different reasons, including to remedy a submission error.

According to one aspect of the present invention, all or a portion of the system of the present invention, such as all or portions of the patient 12, physician 14, administrator 16 and/or sponsor 18, generally operates under control of a computer program product. The computer program product for performing the methods of embodiments of the present invention includes a computer-readable storage medium, such as the non-volatile storage medium, and computer-readable program code portions, such as a series of computer instructions, embodied in the computer-readable storage medium.

In this regard, FIGS. 4, 5 and 6 are control flow diagrams of methods, systems and computer program products according to the invention. It will be understood that each block or step of the control flow diagrams, and combinations of blocks in the control flow diagrams, can be implemented by computer program instructions. These computer program instructions may be loaded onto a computer or other programmable apparatus to produce a machine, such that the instructions which execute on the computer or other programmable apparatus create means for implementing the functions specified in the block(s) or step(s) of the control flow diagrams. These computer program instructions may also be stored in a computer-readable memory that can direct a computer or other programmable apparatus to function in a particular manner, such that the instructions stored in the computer-readable memory produce an article of manufacture including instruction means which implement the function specified in the block(s) or step(s) of the control flow diagrams. The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions specified in the block(s) or step(s) of the control flow diagrams.

Accordingly, blocks or steps of the control flow diagrams support combinations of means for performing the specified functions, combinations of steps for performing the specified functions and program instruction means for performing the specified functions. It will also be understood that each block or step of the control flow diagrams, and combinations of blocks or steps in the control flow diagrams, can be implemented by special purpose hardware-based computer systems which perform the specified functions or steps, or combinations of special purpose hardware and computer instructions.

Many modifications and other embodiments of the invention will come to mind to one skilled in the art to which this invention pertains having the benefit of the teachings presented in the foregoing descriptions and the associated drawings. It should therefore be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. An apparatus comprising:
a processor configured to receive input to enroll a patient in a program of an administrator, the program being directed to a medication administrable to the patient by a prescriber,
wherein the processor is configured to receive recordation of an administering or intended administering of the medication to the enrolled patient by the prescriber, the prescriber also being enrolled in the program of the administrator, the recordation initiating a request for a rebate on a price of the medication, and
wherein in real-time or near-real-time with the request, the processor is configured to process the request to determine an amount of the rebate, and return a response to the request including an indication of the amount of the rebate, the processor thereby facilitating remittance of the rebate amount to the patient.

2. The apparatus of claim 1, wherein the prescriber is enrolled in a plurality of programs of the administrator, the programs being directed to respective medications administrable by a prescriber,
wherein the processor being configured to receive recordation includes being configured to receive identification of the program directed to the medication administered or intended to be administered to the patient, and
wherein the processor being configured to process the request includes being configured to process the request in accordance with established rebate rules for the identified program.

3. The apparatus of claim 1, wherein the processor is further configured to receive input to enroll the prescriber in a plurality of programs of the administrator, the programs being directed to respective, different medications administrable by a prescriber and including the program to which the patient is enrolled, the prescriber being enrolled in the program to which the patient is enrolled before or after receiving input to enroll the patient in the respective program.

4. The apparatus of claim 3, wherein the processor is configured to receive input, receive recordation, process the request and return the response for a plurality of different patients enrolled in a plurality of programs directed to respective, different medications administrable by a prescriber.

5. The apparatus of claim 1, wherein the processor is configured to direct the prescriber to charge the patient the full price of the medication, the administrator being operable to send the rebate amount to the patient as a mailed rebate, stored-value card or added value to a stored-value card.

6. The apparatus of claim 1, wherein the processor is configured to direct the prescriber to charge the patient the full price of the medication less the rebate amount, the administrator being operable to send the rebate amount to the prescriber as a reimbursement.

7. A method comprising:
receiving input to enroll a patient in a program of an administrator, the program being directed to a medication administrable to the patient by a prescriber;
receiving recordation of an administering or intended administering of the medication to the enrolled patient by the prescriber, the prescriber also being enrolled in the program of the administrator, the recordation initiating a request for a rebate on a price of the medication;
processing the request to determine an amount of the rebate;
returning a response to the request including an indication of the amount of the rebate, processing the request and returning the response occurring in real-time or near-real-time with the request; and
remitting the rebate amount to the patient,
wherein one or more of the receiving input, receiving recordation, processing the request or returning the response are performed by one or more processors of the administrator of the program.

8. The method of claim 7, wherein the prescriber is enrolled in a plurality of programs of the administrator, the programs being directed to respective medications administrable by a prescriber,
wherein the received recordation includes identification of the program directed to the medication administered or intended to be administered to the patient, and
wherein processing the request comprises processing the request in accordance with established rebate rules for the identified program.

9. The method of claim 7 further comprising:
receiving input to enroll the prescriber in a plurality of programs of the administrator, the programs being directed to respective, different medications administrable by a prescriber and including the program to which the patient is enrolled, the prescriber being enrolled in the program to which the patient is enrolled before or after receiving input to enroll the patient in the respective program.

10. The method of claim 9, wherein receiving input, receiving recordation, processing the request, returning the response and remitting the rebate amount occur for a plurality of different patients enrolled in a plurality of programs directed to respective, different medications administrable by a prescriber.

11. The method of claim 7, wherein remitting the rebate amount comprises:
directing the prescriber to charge the patient the full price of the medication; and
sending the rebate amount to the patient as a mailed rebate, stored-value card or added value to a stored-value card.

12. The method of claim 7, wherein remitting the rebate amount comprises:
directing the prescriber to charge the patient the full price of the medication less the rebate amount; and
sending the rebate amount to the prescriber as a reimbursement.

13. A computer program product comprising:
a computer-readable storage medium having computer-readable program code portions stored therein,
wherein the computer-readable program code portions are configured to receive input to enroll a patient in a program of an administrator, the program being directed to a medication administrable to the patient by a prescriber,
wherein the computer-readable program code portions are configured to receive recordation of an administering or intended administering of the medication to the enrolled patient by the prescriber, the prescriber also being enrolled in the program of the administrator, the recordation initiating a request for a rebate on a price of the medication, and
wherein in real-time or near-real-time with the request, the computer-readable program code portions are configured to process the request to determine an amount of the rebate, and return a response to the request including an indication of the amount of the rebate, the computer-readable program code portions thereby facilitating remittance of the rebate amount to the patient.

14. The computer program product of claim 13, wherein the prescriber is enrolled in a plurality of programs of the administrator, the programs being directed to respective medications administrable by a prescriber,
wherein the computer-readable program code portions being configured to receive recordation includes being configured to receive identification of the program directed to the medication administered or intended to be administered to the patient, and
wherein the computer-readable program code portions being configured to process the request includes being configured to process the request in accordance with established rebate rules for the identified program.

15. The computer program product of claim 13, wherein the computer-readable program code portions are further configured to receive input to enroll the prescriber in a plurality of programs of the administrator, the programs being directed to respective, different medications administrable by a prescriber and including the program to which the patient is enrolled, the prescriber being enrolled in the program to which the patient is enrolled before or after receiving input to enroll the patient in the respective program.

16. The computer program product of claim 15, wherein the computer-readable program code portions are configured to receive input, receive recordation, process the request and return the response for a plurality of different patients enrolled in a plurality of programs directed to respective, different medications administrable by a prescriber.

17. The computer program product of claim 13, wherein the computer-readable program code portions are configured to direct the prescriber to charge the patient the full price of the medication, the administrator being operable to send the rebate amount to the patient as a mailed rebate, stored-value card or added value to a stored-value card.

18. The computer program product of claim 13, wherein the computer-readable program code portions are configured to direct the prescriber to charge the patient the full price of the medication less the rebate amount, the administrator being operable to send the rebate amount to the prescriber as a reimbursement.
